(19) United States
(12) Patent Application Publication
(10) Pub. No.: US 2024/0255343 A1
(43) Pub. Date: Aug. 1, 2024

(54) PRECISION ROCKER PIN LOAD SUPPORT

(71) Applicant: HOTTINGER BRÜEL & KJAER GMBH, Darmstadt (DE)

(72) Inventors: Werner Schlachter, Rossdorf (DE); URSULA HOST, Griesheim (DE); DANIEL NIEDBALLA, Langen (DE)

(73) Assignee: HOTTINGER BRÜEL & KJAER GMBH, Darmstadt (DE)

(21) Appl. No.: 18/561,178

(22) PCT Filed: Apr. 7, 2022
(86) PCT No.: PCT/DE2022/000039

§ 371 Date: Nov. 15, 2023

(30) Foreign Application Priority Data
May 26, 2021 (DE) 10 2021 002 729.9

(51) Int. Cl. G01G 23/00

(52) U.S. Cl. CPC G01G 23/002

(57) ABSTRACT

A rocker pin load support includes a base plate, a rocker pin bolt, and a rocker pin piece having a cylindrical recess of a diameter greater than a diameter of an upper portion of the rocker pin bolt. The rocker pin bolt is mounted pivotally via a ball-shaped underside thereof in a cylindrical recess of the base plate and pivotally mounting the rocker pin piece via a spherical topside thereof. A bell-shaped cover of elastic plastic has an upper edge portion connected hermetically sealed to the rocker pin piece, and a lower edge portion connected hermetically sealed to the base plate, thereby forming a space for receiving an air or gas filling with the proviso that the gas or air volume is greater than a sum of volumes of portions of the rocker pin bolt and the rocker pin piece which portions are enclosed by the air or gas filling.

The invention relates to a so-called rocker pin load support, which is used in particular in industrial weighing technology in platform scaled or hopper scales. Various forms of constructions are known from the prior art, as described, for example, in the documents DE 102016118046 B4, EP 0 315 846 B1, U.S. Pat. No. 4,815,547 or DE 196 25 821 C1.

The function of rocker pin load supports is to shield transverse forces from load cells so that only the forces caused by the mass of the material being weighed act on the load cells.

There are various demands in industrial weighing technology, such as, e.g., particular demands for hygienic conditions in the food industry. Here, the production plants in which the trolleys are integrated must frequently be cleaned and disinfected. This is carried out, e.g., with steam or hot water blasted under pressure onto the plant components. The steam or water is also admixed with disinfectants. It is necessary that all components of the production plant are designed in such a way as to be capable of being cleaned easily. The presence of gaps or cavities that cannot be reached during cleaning must therefore be avoided, because bacterial cultures could develop in them, a fact that must be ruled out in a food industry. Thus, cleaning of a rocker pin load support must be ensured. Conventionally designed rocker pin load supports do not meet these requirements.

The document DE 102016118046 B4 describes a rocker pin load support which, according to the inventors, is suitable for use in the food industry.

In the pharmaceutical industry, however, demands for sterility are sometimes even more stringent. Furthermore, higher demands are usually placed on dosing accuracy, i.e. the respective pharmaceutical components must be weighed or dispensed sometimes with higher accuracy than in the food industry.

Rocker pin load supports employ point-shaped and/or linear mounts as bearing components in order to achieve the lowest possible frictional resistance. It is known that the phenomenon of the so-called Hertzian pressure occurs at the points of contact, i.e. a flattening at the components in contact. The size of this flattening depends, i.a., on the applied force with which the components are pressed together.

It is known from the art in weighing technology as to how the contact points of such bearing components are to be designed and which materials are preferably suitable for this purpose.

In mechanical precision weighing technology, components are required that have a particularly slight linear, ring-shaped or spot-shaped contact surface. However, as a result, surface pressure becomes very high and the material surfaces in contact are subjected to high loads and wear. In mechanical precision scales, it is even envisaged that the so-called cup and the cutting edge moving in it can be replaced. This design effort cannot be made with a rocker pin support used in industrial scale construction. It must therefore be expected that the mobility of a rocker pin load support will be reduced in the course of time, especially when moisture and possibly aggressive cleaning and disinfecting agents reach the bearing surfaces. Furthermore, there is the problem that a shutdown is undesirable in some production plants and therefore the moving components of the rocker pin load support should have as long a service life as possible.

Accordingly, it is the object of the invention to provide a rocker pin load support with a long service life that retains its mobility throughout its entire service life, even in high humidity and under the influence of aggressive cleaning agents and disinfectants.

The object is attained with a rocker pin load support according to claim 1.

The rocker pin load support includes the following features: A base plate, preferably of stainless steel, in which a cylindrical recess with a planar bottom surface is concentrically provided, a rocker pin bolt with a ball-shaped underside and a spherical topside, and a rocker pin piece with a cylindrical recess with a diameter which is greater than the diameter of the upper portion of the rocker pin bolt. A depression is provided centrally in the bottom surface of this cylindrical recess. The ball-shaped underside of the rocker pin rests on the planar bottom surface of the recess. The rocker pin piece rests with its central recess on the spherical topside of the rocker pin bolt. A bell-shaped cover of an elastic plastic is hermetically sealed to the rocker pin piece at its upper edge portion and hermetically sealed to the base plate at its lower edge portion.

The bell shape of the cover has several advantages: Depending on the requirements, materials with different elasticity and temperature resistance and other desired properties can be used. Formed underneath the cover is a free space, which contains air or a special gas. The gas or air volume is greater than the sum of the volumes of the portions of the rocker pin bolt and the rocker pin piece that are enclosed by the air or gas. This has the effect that the enclosed gas can circulate well and the moisture it contains remains constant at all points, so that e.g. condensation of the moisture due to temperature changes is largely avoided at specific points or condensed moisture evaporates again quickly. This is of advantage because, e.g., the lubricants used retain their lubricity longer.

According to claim 2, the cover is made of an antibacterial plastic, a fact that has particular advantages when used in the food industry and in the pharmaceutical industry.

According to claim 3, as an alternative to the subject matter of claim 2, only the outer surface of the cover is provided with an antibacterial coating.

According to claim 4, the cover is made of at least two material layers. Two or more layers of material increase flexibility of the cover. The cover becomes more flexible and thus does not distort the forces resulting from the masses to be weighed. The outer layer of the cover can be made of a material with an antibacterial effect.

According to claim 5, a hygroscopic substance is placed within the air or gas filling to keep the moisture of the gas low. This ensures that the lubricants remain effective for a long time.

According to claim 6, the gas filling is an inert gas. This also achieves a long effectiveness of the lubricants.

The invention is explained in greater detail hereinafter with reference to schematic drawings:

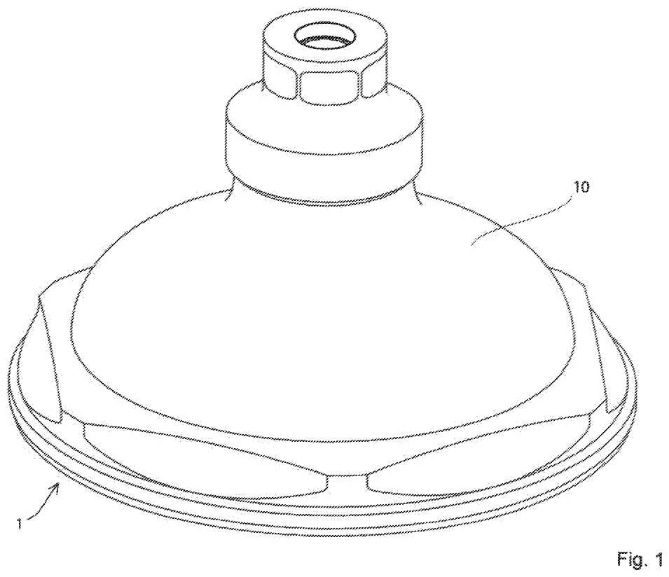

FIG. 1 shows a perspective view of a rocker pin load support,

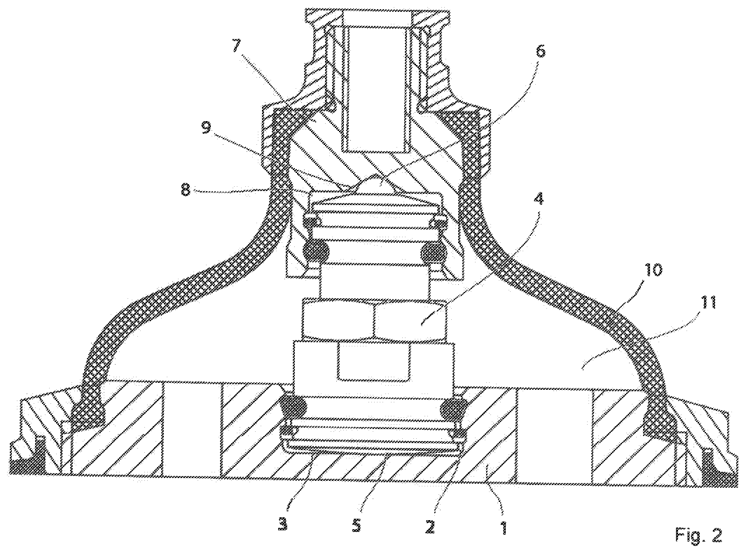

FIG. 2 shows a cross section of the rocker pin load support,

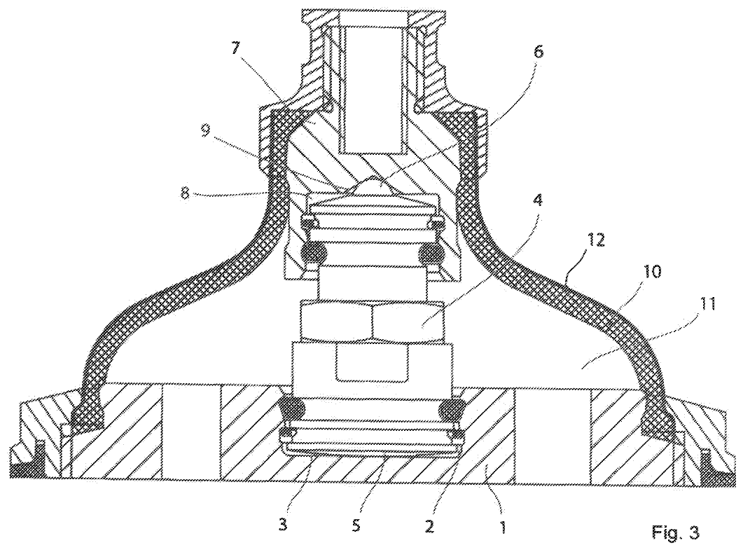

FIG. 3 shows a cross section of a second embodiment of a rocker pin load support,

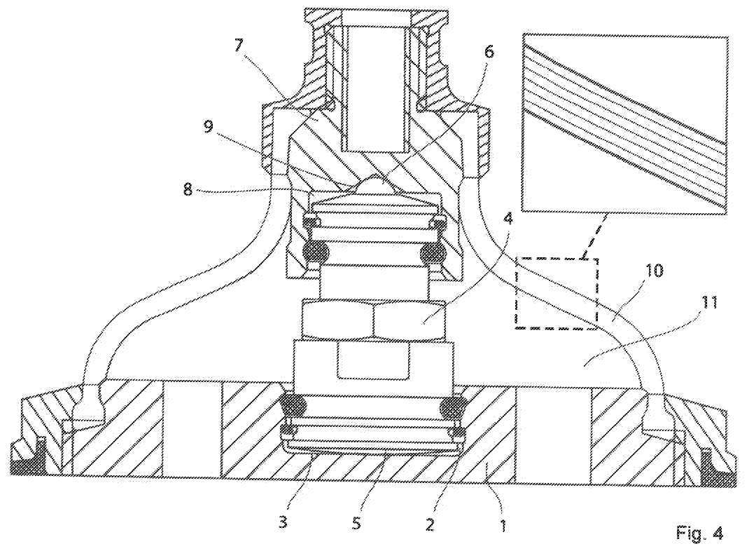

FIG. 4 shows a cross section of a third embodiment of a rocker pin load support,

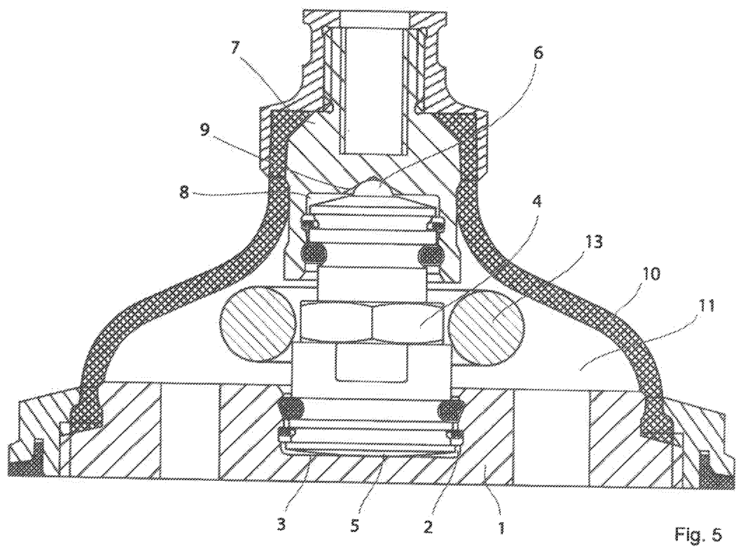

FIG. 5 shows a cross section of a fourth embodiment of a rocker pin load support, and

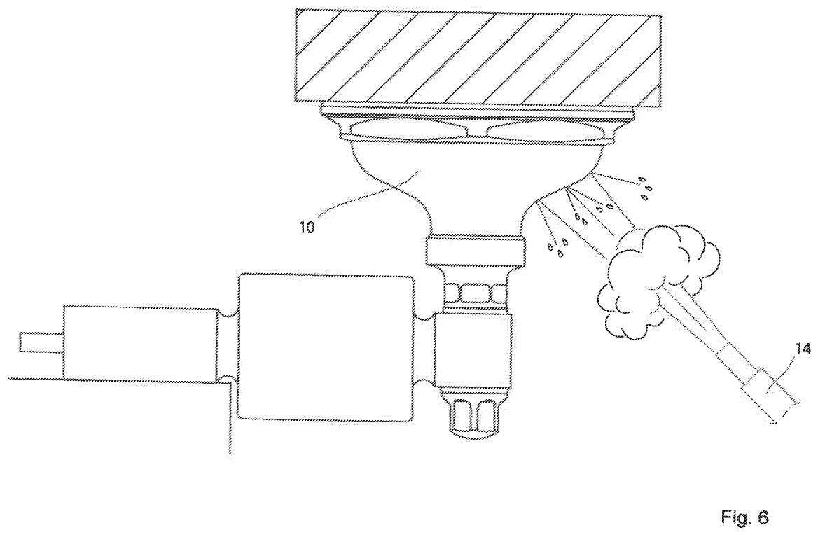

FIG. 6 shows the installed rocker pin load support during cleaning and disinfection.

### LIST OF REFERENCE SIGNS

1 Base plate
2 cylindrical recess in the base plate
3 planar bottom surface of the cylindrical recess
4 rocker pin bolt
5 ball-shaped underside of the rocker pin bolt
6 spherical topside of the rocker pin bolt
7 rocker pin piece
8 cylindrical recess in the rocker pin piece
9 conical depression in the rocker pin piece
10 bell-shaped cover
11 air or gas filling
12 antibacterial coating
13 hygroscopic substance
14 cleaning device

FIG. 1 shows a rocker pin load support in a perspective view. FIG. 2 shows the rocker pin load support in cross section. The rocker pin load support includes the following features: A base plate 1 made of stainless steel and having a topside on which provision is made for a concentric cylindrical recess 2 with a planar bottom surface 3, a rocker pin bolt 4 with a ball-shaped underside 5 and a spherical topside 6, a rocker pin piece 7 with a cylindrical recess 8 of a diameter which is greater than the diameter of the upper portion of the rocker pin bolt 4, and a centrally introduced conical depression 9. The lower portion of the rocker pin bolt 4 is inserted in the cylindrical recess 2 of the base plate 1 and the rocker pin piece 7 rests on the spherical topside of the rocker pin bolt 4.

A bell-shaped cover 10 of an elastic plastic is connected at its upper edge portion hermetically sealed to the rocker pin piece 7 and at its lower edge portion to the base plate 1 in a hermetically sealed manner. Preferably, the connection at the upper edge portion is an adhesive bond; if need be, however, the connection may also be a clamping. The connection to the base plate is preferably detachable, e.g. a clamping by bolting. The space underneath the cover 10 is filled with air or gas 11.

In the rocker pin load support shown in FIG. 3, only the outer surface of the cover 10 includes an antibacterial coating 12. This has the advantage that the cover can be made of a particularly flexible and gas-tight plastic and still have an antibacterial effect.

In the rocker pin load support shown in FIG. 4, the cover 10 is made of 6 layers of material. This arrangement has various advantages. For example, the outer material layer can be selected to be thin but resistant to aggressive cleaning agents. The inner layers are made of particularly soft elastic material. The individual layers are not connected to one another.

In the rocker pin load support shown in FIG. 5, a hygroscopic substance 13 is incorporated in the air or gas filling 11. This ensures that the lubricants remain effective for a long time.

FIG. 6 shows an installation situation in which the rocker pin load support that is installed in a facility is cleaned by means of a steam jet 14.

1.-6. (canceled)

7. A rocker pin load support, comprising:
a base plate designed to include a concentric cylindrical recess with a planar bottom surface;
a rocker pin bolt designed to include a ball-shaped underside and a spherical topside;
a rocker pin piece designed to include a cylindrical recess of a diameter which is greater than a diameter of an upper portion of the rocker pin bolt, and a centrally introduced depression, with the rocker pin bolt being mounted pivotally in the cylindrical recess of the base plate via the ball-shaped underside thereof and pivotally mounting the rocker pin piece via the spherical topside thereof;
a bell-shaped cover of elastic plastic, said cover having an upper edge portion which is connected hermetically sealed to the rocker pin piece, and a lower edge portion which is connected hermetically sealed to the base plate, so that a space is formed; and
an air or gas filling received in the space and governed with the proviso that the gas or air volume is greater than a sum of volumes of portions of the rocker pin bolt and the rocker pin piece which are enclosed by the air or gas filling.

8. The rocker pin load support of claim 7, wherein the cover is made of an antibacterial plastic.

9. The rocker pin load support of claim 7, further comprising an antibacterial coating applied upon the cover.

10. The rocker pin load support of claim 7, wherein the cover is made of at least two plastic layers.

11. The rocker pin load support of claim 7, further comprising a hygroscopic substance placed in the air or gas filling.

12. The rocker pin load support of claim 7, wherein the gas filling is an inert gas.
